(19) United States
(12) Patent Application Publication
(10) Pub. No.: US 2013/0189932 A1
(43) Pub. Date: Jul. 25, 2013

(54) BASE STATION, USER EQUIPMENT AND METHOD OF REDUCING ENERGY CONSUMPTION IN A BASE STATION

(71) Applicants: Gang Shen, PuDong Jinqiao Shanghai (CN); Wei Wang, PuDong Jinqiao Shanghai (CN); Wu Zheng, PuDong Jinqiao Shanghai (CN)

(72) Inventors: Gang Shen, PuDong Jinqiao Shanghai (CN); Wei Wang, PuDong Jinqiao Shanghai (CN); Wu Zheng, PuDong Jinqiao Shanghai (CN)

(73) Assignee: ALCATEL LUCENT, Paris (FR)

(21) Appl. No.: 13/876,096

(22) PCT Filed: Sep. 7, 2011
(86) PCT No.: PCT/IB11/02461

§ 371 Date: Mar. 26, 2013

(30) Foreign Application Priority Data
Sep. 28, 2010 (CN) 201010295651.X

(51) Int. Cl. H04W 52/02

(52) U.S. Cl. CPC H04W 52/0206
USPC 455/68; 455/561

(57) ABSTRACT

The present invention provides a novel base station, a novel user equipment and a method of reducing energy consumption in a base station. According to the present invention, when detecting no user service for a time period, the base station switches off its transmitter and keeps its receiver switched on, thereby entering into a sleep state; when receiving a wake-up signal, the base station switches on the transmitter, thereby entering into a wake-up state. The method switches off the transmitter to reduce energy consumption when there is no user service, and wakes up the base station intelligently when a user comes.

### FIELD OF THE INVENTION

The present invention generally relates to mobile communication technology, and more particularly, to base stations and user equipments in a mobile communication network, and a method of reducing energy consumption in a base station.

### BACKGROUND OF THE INVENTION

Energy consumption has an important impact on the economy and the environment. With the great increase in the number of mobile equipments and base stations, carbon emission and energy expenditure has become an operation payload that any operator cannot afford to overlook, inducing an urgent demand for energy reduction.

In a mobile communication network, base stations need a great amount of energy and have great effects on the operation cost and the environment. Thus, reducing energy consumption in base stations is placed in an important position as far as energy saving is concerned. For example, an ordinary base station has energy consumption of 1000 watts. In contrast to a user equipment, which may reduce its energy consumption by means of sleep, the transmitter and the receiver of a base station are always kept in a switched-on state. Traffic of a base station varies greatly in different time period. For example, the traffic is light and is concentrated to a small amount of base stations late at night. Moreover, some base stations may have no traffic in a time period. However, even if there is no (active) user service, the base station has to keep the transmitter and the receiver switched on, resulting in unnecessary energy consumption.

The problem is even worse for a micro cell (e.g., a relay station, a micro base station, or a femto base station, etc.). Take a femto base station as an example, which usually serves a small amount of users. The users may go to work in the daytime and thus the femto may have no user service during the whole daytime. Similarly, the probability of user access late at night is also low. Although the chance for a femto to serve users is low, it still has to keep the transmitter and the receiver switched on.

To ensure that user equipments can acquire necessary control information to complete normal network access and handover, the femto has to keep transmitting control information, even when there is no user service. The control information includes Physical Synchronization Channel (SCH), Physical Control Format Indicator Channel (PCFICH), Physical Broadcast Channel (PBCH), etc. Likewise, the femto base station has to keep the receiver switched on because users may access in Random Access Channel. And energy consumption of the transmitter is much more than that of the receiver.

A known optimum solution to energy reduction of a femto base station is periodical sleep and waking-up. In other words, when there is no user service, the femto base station periodically switches off the transmitter and switches it on later. During a wake-up period, the femto base station transmits necessary control signal to complete user access and handover. If there is no user access or handover, the femto base station enters into its sleep period again. Reduce energy consumption as the solution can, there are some disadvantages:

1. If the sleep period is set long so as to reduce more energy consumption, user equipments has to wait for a long time before getting accessed or transmitting data. And long latency may result in access failure.

2. Even if it has been long (e.g., a whole day) since there was user service, the femto base station has to be waked up periodically. Usually, sleep time cannot be set excessively long to avoid long user latency or access failure. Thus, the femto base station has to be waked up frequently, resulting in unnecessary energy waste.

3. If a user is handed over from a serving cell to a sleeping femto, severe delay may occur. Except for ceasing the sleep period, no mechanism is provided to wake up the femto base station.

### SUMMARY OF THE INVENTION

The present invention provides a novel base station, a novel user equipment and a method of reducing energy consumption in a base station to solve the above defects in the prior art. According to the present invention, when detecting no user service for a time period, the base station switches off its transmitter and keeps its receiver switched on, thereby entering into a sleep state; when receiving a wake-up signal, the base station switches on the transmitter, thereby entering into a wake-up state. The method switches off the transmitter to reduce energy consumption when there is no user service, and wakes up the base station intelligently when a user comes.

Specifically, according to an embodiment of the present invention, a method of reducing energy consumption in a base station is provided. The method includes: switching off a transmitter of the base station, and keeping a receiver of the base station in an switched-on state when the base station has detected no user service for a time period, thereby making the base station enter into a sleep state; and switching on the transmitter when the base station receives a wake-up signal, thereby making the base station enter into a wake-up state.

According to an alternative embodiment of the present invention, the wake-up signal received by the base station is an uplink wake-up triggering signal from a user equipment.

According to an alternative embodiment of the present invention, the uplink wake-up triggering signal received by the base station is transmitted at a predetermined frequency and in a predetermined sequence.

According to an alternative embodiment of the present invention, the uplink wake-up triggering signal received by the base station has a strength greater than a preset wake-up triggering signal threshold.

According to an alternative embodiment of the present invention, the base station switches on the transmitter when the base station in the sleep state detects that a strength of an uplink signal of a neighboring cell is greater than a preset threshold, thereby entering into the wake-up state, and the wake-up signal is the uplink signal of the neighboring cell whose strength is greater than the preset threshold.

According to an alternative embodiment of the present invention, the base station switches on the transmitter when the base station in the sleep state receives the wake-up signal from a neighboring base station, thereby entering into the wake-up state, and the neighboring base station transmits the wake-up signal when it detects that link quality of a user equipment is lower than a preset first link quality threshold.

According to an alternative embodiment of the present invention, the neighboring base station transmits the wake-up signal to the base station in the sleep state to which the user equipment is adjacent according to location information of the user equipment, whose link quality is lower than the preset first link quality threshold.

According to an alternative embodiment of the present invention, the wake-up signal from the neighboring base station is transmitted to the base station through an X2 interface.

According to an alternative embodiment of the present invention, the wake-up signal is an uplink wake-up triggering signal from a user equipment of a neighboring base station, and the neighboring base station notifies the user equipment to transmit the uplink wake-up triggering signal when it detects that link quality of the user equipment is lower than a preset second link quality threshold.

According to an alternative embodiment of the present invention, the base station and/or the neighboring base station is a femto base station, a relay station, a micro base station, or a macro base station.

According to an embodiment of the present invention, a base station with reduced energy consumption is provided. The base station includes:

a transmitting device for transmitting a signal to a user equipment;

a receiving device for receiving a wake-up signal and an uplink signal from the user equipment;

a detecting device for detecting existence of user service according to output signals of the receiving device and the transmitting device and for detecting reception of the wake-up signal according to an output signal of the receiving device;

a timer device for counting a time without user service according to an output signal of the detecting device; and

a switching device for switching on or off the transmitting device, wherein the switching device switches off the transmitting device when the time without user service counted by the timer device reaches a preset time threshold, thereby making the base station operate in a sleep state, and switches on the transmitting device when the detecting device detects the wake-up signal, thereby making the base station operate in a wake-up state.

According to an alternative embodiment of the present invention, the wake-up signal is an uplink wake-up triggering signal from the user equipment.

According to an alternative embodiment of the present invention, the uplink wake-up triggering signal is transmitted at a predetermined frequency and in a predetermined sequence.

According to an alternative embodiment of the present invention, the uplink wake-up triggering signal has a strength greater than a preset wake-up triggering signal threshold.

According to an alternative embodiment of the present invention, the wake-up signal received by the receiving device is an uplink signal from a neighboring cell whose strength is greater than a preset threshold.

According to an alternative embodiment of the present invention, the wake-up signal received by the receiving device is a wake-up signal from a neighboring base station.

According to an alternative embodiment of the present invention, the wake-up signal is transmitted to the base station through an X2 interface by the neighboring base station.

According to an alternative embodiment of the present invention, the wake-up signal is an uplink wake-up triggering signal from the user equipment of a neighboring base station.

According to an alternative embodiment of the present invention, the receiving device inputs the uplink signal of the user equipment to the detecting device after the receiving device receives and processes it, and the transmitting device generates the wake-up signal and transmits it to a neighboring base station in the sleep state when the detecting device detects that link quality of the user equipment is lower than a preset first link quality threshold.

According to an alternative embodiment of the present invention, the base station further includes a location estimation device for estimating location information of the user equipment, wherein the transmitting device transmits the wake-up signal to only a neighboring base station in the sleep state to which the user equipment, whose link quality is lower than the preset first link quality threshold, is adjacent.

According to an alternative embodiment of the present invention, the base station transmits the wake-up signal to the neighboring base station through an X2 interface.

According to an alternative embodiment of the present invention, the base station further includes a resource scheduling device, wherein after the receiving device receives and processes the uplink signal of the user equipment and then inputs it to the detecting device and the detecting device detects that link quality of the user equipment is lower than a preset second link quality threshold, the resource scheduling device schedules the user equipment to transmit an uplink wake-up triggering signal and reserves resource for the user equipment to transmit the wake-up triggering signal.

According to an embodiment of the present invention, a user equipment is provided. The user equipment includes a signal generation and transmission device for generating and transmitting an uplink wake-up triggering signal.

According to an alternative embodiment of the present invention, the user equipment further includes a detecting device for detecting a serving base station, wherein a result of the detecting device is output to the signal generation and transmission device, and the signal generation and transmission device is switched on, generates and transmits the uplink wake-up triggering signal when the detecting device doesn't detect a serving base station whose SINR is greater than a preset threshold.

According to an alternative embodiment of the present invention, the signal generation and transmission device is switched on and directly transmits the uplink wake-up triggering signal after the user equipment enters to a network.

According to an alternative embodiment of the present invention, the user equipment further includes a receiving device for receiving scheduling information from a base station, wherein the signal generation and transmission device is switched on, generates and transmits the uplink wake-up triggering signal after the receiving device receives the scheduling information.

According to an alternative embodiment of the present invention, the uplink wake-up triggering signal is generated and transmitted at a predetermined frequency and in a predetermined sequence.

According to the present invention, when the femto base station has no active user service, the transmitter is switched off to reduce energy consumption of the femto base station, without impacting network access and network handover of users. Therefore, as compared with the prior art, energy consumption of the femto base station is greatly reduced.

### BRIEF DESCRIPTION OF THE DRAWINGS

After reading the following detailed description in connection with the accompanying drawings, and with a more comprehensive understanding of the present invention, other objectives and effects of the present invention will become more apparent and more readily understood, wherein below:

FIG. 1 is a diagram illustrating a process of user equipment's access to a network according to an embodiment of the present invention.

FIG. 2 is a structural diagram illustrating a base station according to an embodiment of the present invention.

FIGS. 3a, 3b and 3c are structural diagrams illustrating a user equipment according to an embodiment of the present invention.

In all the above figures, identical reference signs indicate identical, similar or corresponding features or functions.

### DETAILED DESCRIPTION OF PREFERRED EMBODIMENTS

Embodiments of the present invention are described in detail in connection with the accompanying drawings.

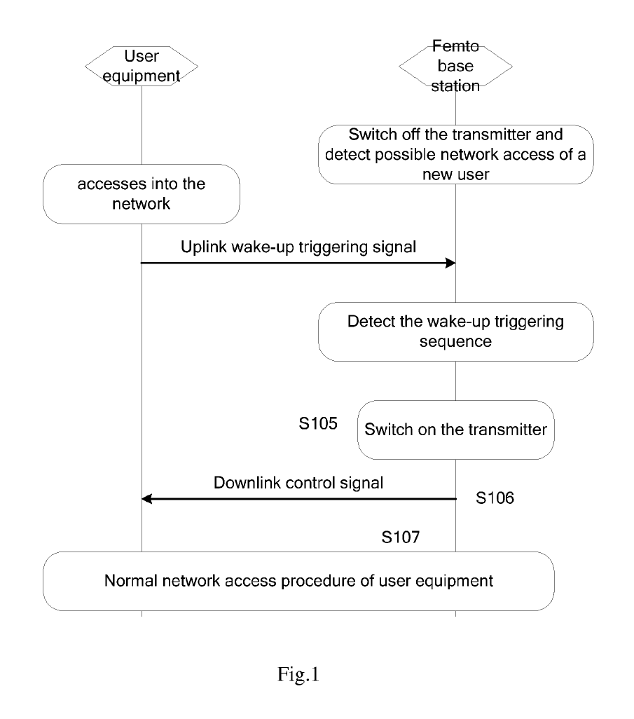

FIG. 1 is a diagram illustrating a process of user equipment's access to a network according to an embodiment of the present invention. The embodiment may be applied to a femto base station, a relay station, a micro base station, or a macro base station, etc., and a user equipment served by them. A femto base station taken as an example, detailed description is provided hereinafter. Firstly, in step S101, the femto base station detects whether there is an active user equipment, and switches off its transmitter to reduce energy consumption when the femto base station finds that it has last for a time since there is no active user in the cell, and thereby the base station enters into a sleep state; the receiver is kept switched on, and the base station in the sleep state keeps uplink searching for possible user access. Optionally, the base station may search a triggering signal at different carriers. In step S102, when the user equipment enters into the network, the user equipment first searches, according to normal procedure, suitable synchronization signaling such as Primary Synchronization Sequence (PSS)/Secondary Synchronization Sequence (SSS). If the user equipment doesn't detect a serving base station whose SINR is greater than a preset threshold, the user equipment transmits an uplink wake-up triggering signal in step S103 to wake up the base station, which may be in the sleep state. The frequency and the sequence of the uplink wake-up triggering signal are configured in advance, and are known to both the base station and the user equipment. Because the base station in the sleep state keeps uplink searching, in step S104, the base station receives the uplink wake-up triggering signal and detects that it has a strength greater than a preset threshold. Then in step S105, the base station is waked up, enters into a wake-up state, and switches on its transmitter. In step S106, the base station transmits a downlink control signal, such as PSS/SSS, PBCH, PCHICH, etc. And then in step 107, the user equipment has got synchronization signal and necessary system information, and completes network entrance according to normal procedure.

Optionally, the user equipment may transmit the wake-up triggering signal when it is powered on. The omission of step S102 of the searching aids in reducing network access delay.

When the user equipment moves from a neighboring cell to a sleeping base station, some new mechanisms are needed to wake up the sleeping base station and help the user equipment to complete neighboring cell measurement and handover. Three embodiments of waking up the sleeping base station and helping the user equipment to complete neighboring cell measurement and handover according to the present invention are described in detail hereinafter.

In embodiment 1, while detecting the wake-up signal, the base station also detects uplink signal strength of neighboring cells. Optionally, if the base station and a neighboring cell operate at different carriers, the base station needs to sensor uplink signal strength of the neighboring cell at the carrier of the neighboring cell. If the base station finds that the uplink signal strength of the neighboring cell is greater than a preset threshold, it judges that certain user equipment(s) is/are at the cell edge and possible to handover to its cell. Then, the base station is waked up, switches on its transmitter, and transmits a control signal for measurement and handover of the user equipment(s) of the neighboring cell.

In embodiment 2, if a serving base station detects that a user equipment has such low link quality that is lower than a preset threshold, the base station may wake up a neighboring sleeping base station such that the user equipment with low link quality can perform handover. Such information may be interchanged through an X2 interface. Optionally, the base station is able to know rough location information of the user equipment with low link quality via, for example, positioning functionality supported by 3GPP, such that it can inform and wake up only a sleeping base station to which the user equipment is adjacent. Once the sleeping base station receives the wake-up signal from the neighboring base station through the X2 interface, it judges that some user equipment of the neighboring base station needs to handover to the sleeping base station and therefore switches on its transmitter, thereby entering into the wake-up state to facilitate handover of the user equipment with low link quality in the neighboring base station to the base station.

In embodiment 3, if a user equipment has link quality lower than a preset threshold, the serving cell of the user equipment may schedule the user equipment to transmit an uplink wake-up triggering signal and reserves resource for the user equipment to transmit the uplink wake-up triggering signal. When a neighboring sleeping base station receives the uplink wake-up triggering signal from the user equipment in the neighboring cell and detects that its strength is greater than a preset threshold, the neighboring sleeping base station switches on its transmitter, thereby entering into the wake-up state to facilitate handover of the user equipment with low link quality in the neighboring base station to the base station.

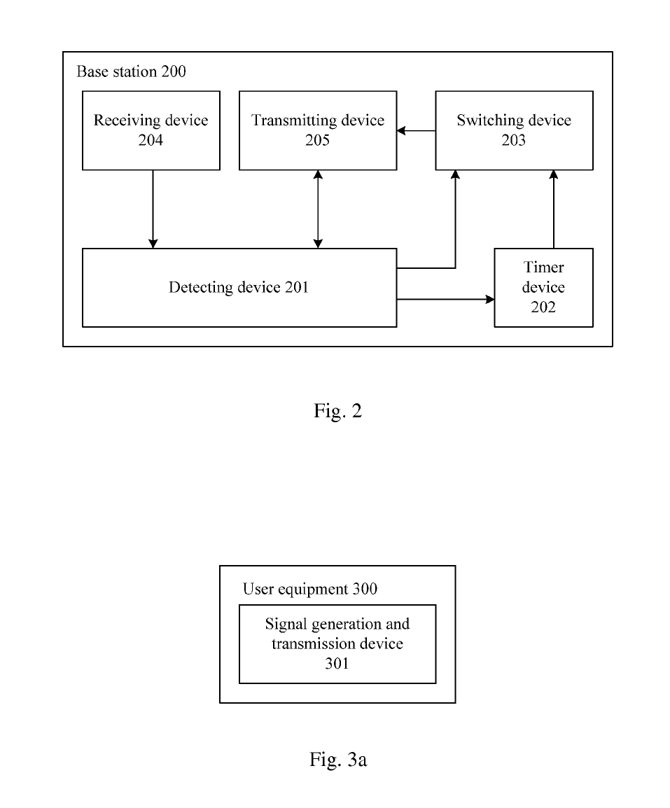

FIG. 2 is a structural diagram illustrating a base station according to an embodiment of the present invention. The base station 200 includes a detecting device 201, a timer device 202, a switching device 203, a receiving device 204, and a transmitting device 205.

Specifically, after the base station 200 is powered on, each device is initialized and enters into a normal operation state. The transmitting device 205 is utilized for transmitting a signal to a user equipment. The receiving device 204 is utilized for receiving an uplink signal from the user equipment. The detecting device 201 is configured to detect existence of user service. Existence of user service may be judged according to whether or not the receiving device and the transmitting device have uplink and downlink data transmission, respectively, or according to other criteria, which doesn't affect the scope of the present invention. An output of the detecting device 201 is connected to the timer device 202, which is utilized for counting a time without user service. An output of the timer device 202 is connected to the switching device 203. The switching device 203 is utilized for switching on or off the transmitting device. When the time without user service counted by the timer device 202 reaches a preset time threshold, the timer device 202 outputs a signal to the switching device 203, which in turn outputs a signal to the transmitting device 205 to switch it off, thereby making the base station 200 operate in a sleep state. At that time, the receiver is kept in an operation state and continues searching for possible user access. Optionally, the base station 200 may search the triggering signal at different carriers. The detecting device 201 is also utilized for detecting whether the receiving device 204 receives a wake-up signal when in the sleep state. When the detecting device 201 detects that the receiving device 204 receives a wake-up signal and such a wake-up signal is greater than a preset threshold, the detecting device 201 outputs a signal to the switching device 203. And the switching device 203 in turn outputs a signal to the transmitting device 205 to switch it on, thereby making the base station 200 operate in the wake state.

There are several kinds of wake-up signal received by the sleeping base station 200.

1. When the base station 200 is in the sleep state, the wake-up signal received by the receiving device 204 is an uplink wake-up triggering signal from a user equipment in the local cell that needs network access. When the user equipment performs network access, it fails to detect a serving base station whose SINR is greater than a preset threshold, because the base station is in a sleep state. Therefore, the user equipment transmits an uplink wake-up triggering signal to wake up the sleeping base station. Optionally, the user equipment may transmit the uplink wake-up triggering signal once it is powered on, thereby reducing network access delay. The frequency and the sequence of the uplink wake-up triggering signal are configured in advance and known to both the base station and the user equipment. Because the receiving device 204 of the sleeping base station keeps uplink searching, it can receive the uplink wake-up triggering signal, and when the detecting device 201 detects that the uplink wake-up triggering signal has a strength greater than a preset threshold, the base station is waked up and switches on the transmitting device 205, thereby entering into a wake-up state.

2. When the base station 200 is in the sleep state, the wake-up signal received by the receiving device 204 is an uplink signal from a neighboring cell whose strength is greater than a preset threshold. The base station 200 detects uplink signal strength of neighboring cells while detecting a wake-up signal. Optionally, when the base station and a neighboring cell operate at different carriers, the base station needs to sensor uplink signal strength of the neighboring cell at the carrier of the neighboring cell. If the detecting device 201 finds that the uplink signal strength of the neighboring cell is greater than a preset threshold, it judges that certain user equipment(s) is/are at the cell edge and possible to handover to the local cell. Then, the detecting device outputs a signal to the switching device 203 to switch on the transmitting device 205. Thus, the base station is waked up, and the transmitting device starts working and transmits a control signal for measurement and handover of the user equipment(s) of the neighboring cell.

3. When the base station 200 is in the sleep state, the wake-up signal received by the receiving device 204 is a wake-up signal from a neighboring base station. If a neighboring base station of a sleeping base station operates in a wake state, such a neighboring base station is called a serving base station. If the serving base station detects that a user equipment has such low link quality that is lower than a preset threshold, it may wake up the neighboring sleeping base station to facilitate handover of the user equipment with low link quality. Such information may be interchanged through an X2 interface. Optionally, the serving base station is able to know rough location information of the user equipment with low link quality via, for example, positioning functionality supported by 3GPP, such that it can inform and wake up only a sleeping base station to which the user equipment is adjacent. Once the receiving device 204 of the sleeping base station receives the wake-up signal from the neighboring base station through the X2 interface, its detecting device 201 judges that some user equipment of the neighboring base station needs to handover to the sleeping base station. Therefore, the detecting device outputs a signal to the switching device 203 to switch on the transmitting device 205, thereby waking up the base station 200 to facilitate handover of the user equipment with low link quality in the neighboring base station to the base station. In such a situation, when the base station 200 operates in a wake-up state, its receiving device 204 receives and processes the uplink signal of the user equipment, and then outputs it to the detecting device 201. When the detecting device 201 detects that link quality of the user equipment is lower that a preset first link quality threshold, it outputs a signal to the transmitting device 205. The transmitting device 205 in turn generates a wake-up signal and transmits it to the neighboring sleeping base station. Preferably, such information may be transmitted through an X2 interface. Optionally, the base station 200 further includes a location estimation device for estimating location information of the user equipment via, for example, positioning functionality supported by 3GPP. Thus, the base station 200 is able to know rough location information of the user equipment with low link quality, thereby being able to inform and wake up only a sleeping base station to which the user equipment is adjacent.

4. When the base station 200 is in the sleep state, the wake-up signal received by the receiving device 204 is an uplink wake-up triggering signal from a user equipment in a neighboring cell that needs to be handed over to the base station 200. The processing in the base station 200 is similar to that in case 1, and the receiving device 204 of the base station in sleep state keeps uplink searching. Therefore, when the receiving device 204 of the base station 200 receives an uplink wake-up triggering signal and the detecting device 201 detects that strength of the signal is greater than a preset threshold, the base station 200 is waked up and switches on its transmitting device 205, thereby entering into a wake-up state. In such a situation, the base station 200 operated in the wake-up state further includes a resource scheduling device 207. After the receiving device 204 receives and processes the uplink signal of the user equipment and then inputs it to the detecting device 201 and the detecting device 201 detects that link quality of the user equipment is lower than a preset second link quality threshold, the resource scheduling device 207 schedules the user equipment to transmit an uplink wake-up triggering signal and reserves resource for the user equipment to transmit the wake-up triggering signal.

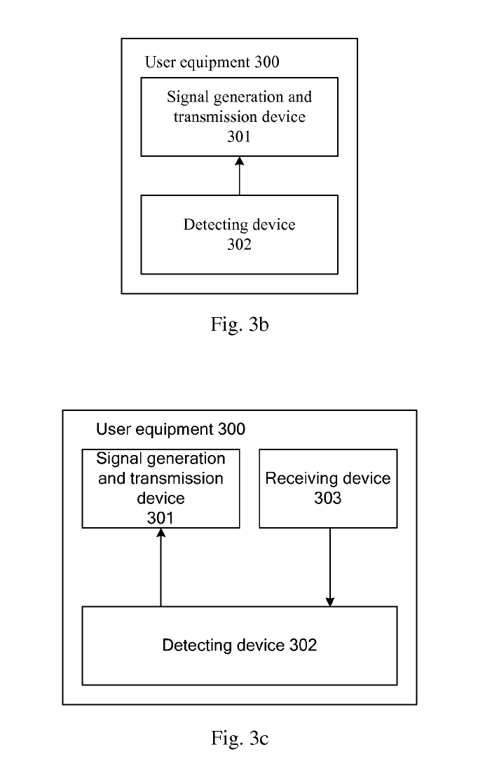

FIG. 3 is a structural diagram illustrating a user equipment according to an embodiment of the present invention.

As shown in FIG. 3a, a user equipment 300 includes a signal generation and transmission device 301.

Specifically, the signal generation and transmission device 301 is utilized for generating and transmitting an uplink wake-up triggering signal. The user equipment 300 may be configured to initialize the signal generation and transmission device 301 to generate and transmit the uplink wake-up triggering signal once the user equipment 300 is powered on. When the user equipment 300 receives a downlink control signal, such as PSS/SSS, PBCH, PCHICH, etc., from a base station, the user equipment 300 obtains synchronization signal and necessary system information, and completes network access according to normal procedure.

An alternative solution is shown in FIG. 3b, where the user equipment further includes a detecting device 302 for detecting a serving base station. The result of the detecting device 302 is output to the signal generation and transmission device 301. When the detecting device 302 doesn't detect a serving base station whose SINR is greater than a preset threshold, the signal generation and transmission device 301 is switched on and generates an uplink wake-up triggering signal and transmits it. When the user equipment 300 receives a downlink control signal, such as PSS/SSS, PBCH, PCHICH, etc., from a base station, the user equipment 300 obtains synchronization signal and necessary system information, and completes network access according to normal procedure.

An alternative solution is shown in FIG. 3c, where the user equipment further includes a receiving device 303 for receiving scheduling information from a base station. When the receiving device receives the scheduling information, which is then detected by the detecting device 302, the signal generation and transmission 301 is switched on, generates and transmits the uplink wake-up triggering signal.

Corresponding to the base station, the frequency and the sequence of the uplink wake-up triggering signal are configured in advance and known to both the base station and the user equipment.

In the present invention, in order to facilitate interference cancellation and signal detection, the wake-up signal should have characteristics similar to those of noise (e.g., a CDMA M sequence or a Golden sequence). Usually, such a sequence is transmitted at the center frequency band of the bandwidth. Therefore, the location remains unchanged even if the system bandwidth is changed. The base station keeps search at the center frequency band, or it may search at a different carrier. And a Zadoff-Chu sequence is recommended (Zadoff-Chu sequences are widely used in the LTE as a random access preamble, an uplink reference signal, a PSS, etc.).

According to user behavior characteristics, some particular time intervals are chosen adaptively to apply the present invention. For example, the base station is kept switched on during day time, and detects existence of user equipment late at night. If it has last a time period since there was no user service, the base station switches off its transmitter and sensors possible wake-up triggering.

It is common for the base station to have no user service. The present invention saves energy by switching off the transmitter of the base station and ceasing corresponding baseband processing. And the base station is waked up intelligently when a user comes or needs to be handed over. Since the transmitter consumes more energy than the receiver, the present invention can reduce energy consumption effectively.

As compared with a conventional periodical sleep/wake method in a femto base station, the advantages of the present invention are as follows:

1. The present invention can “thoroughly” switch off the transmitter of the base station. The conventional method needs periodical waking-up to transmit some control signaling even when there is no user data.

2. According to the method of the present invention, network access or handover of the user equipment has a shorter delay, as is different for the conventional method, where network access or handover of the user equipment has a longer delay when the base station is in its sleeping period.

3. The present invention provides a method of handing the user equipment over to the sleeping base station, while the conventional method fails to hand the user equipment over to the sleeping base station.

The present invention may be implemented as a hardware, a software, a firmware, or a combination thereof. Those skilled in the art will understand that the present invention may be implemented in a computer program product disposed on any signal carrying medium suitable for use in a data processing system. Such a signal carrying medium may be a transmission medium or a recordable medium used for machine-readable information, such as a magnetic medium, an optic medium, or other suitable medium. Examples of recordable medium include: a hard disk in a hard disk drive, a floppy disk, an optical disk for use with a CD-ROM drive, a magnetic tape, or other medium envisioned by those skilled in the art. And those skilled in the art will also understand that any communication apparatus with suitable programmable device can execute the steps of the method of the present invention as embodied by the program product.

It will be understood from the above description that modifications and variations to the disclosed embodiments of the present invention can be made without departing from the spirit of the present invention. And the description in the specification is only explanatory rather than limiting. Therefore, the scope of the present invention is limited by only the issued claims.

1. A method of reducing energy consumption in a base station, the method comprising:
switching off a transmitter of the base station, and keeping a receiver of the base station in an switched-on state when the base station has detected no user service for a time period, thereby making the base station enter into a sleep state; and
switching on the transmitter when the base station receives a wake-up signal, thereby making the base station enter into a wake-up state.

2. The method of claim 1, wherein the wake-up signal received by the base station is an uplink wake-up triggering signal from a user equipment.

3. The method of claim 2, wherein the uplink wake-up triggering signal received by the base station is transmitted at a predetermined frequency and in a predetermined sequence.

4. The method of claim 2, wherein the uplink wake-up triggering signal received by the base station has a strength greater than a preset wake-up triggering signal threshold.

5. The method of claim 1, wherein the base station switches on the transmitter when the base station in the sleep state detects that a strength of an uplink signal of a neighboring cell is greater than a preset threshold, thereby entering into the wake-up state, and the wake-up signal is the uplink signal of the neighboring cell whose strength is greater than the preset threshold.

6. The method of claim 1, wherein the base station switches on the transmitter when the base station in the sleep state receives the wake-up signal from a neighboring base station, thereby entering into the wake-up state, and the neighboring base station transmits the wake-up signal when it detects that link quality of a user equipment is lower than a preset first link quality threshold.

7. The method of claim 6, wherein the neighboring base station transmits the wake-up signal to the base station in the sleep state to which the user equipment is adjacent according to location information of the user equipment, whose link quality is lower than the preset first link quality threshold.

8. The method of claim 6, wherein the wake-up signal from the neighboring base station is transmitted to the base station through an X2 interface.

9. The method of claim 1, wherein the wake-up signal is an uplink wake-up triggering signal from a user equipment of a neighboring base station, and the neighboring base station notifies the user equipment to transmit the uplink wake-up triggering signal when it detects that link quality of the user equipment is lower than a preset second link quality threshold.

10. (canceled)

11. A base station with reduced energy consumption, the base station comprising:
a transmitting device for transmitting a signal to a user equipment;
a receiving device for receiving an uplink signal from the user equipment and a wake-up signal;
a detecting device for detecting existence of user service according to output signals of the receiving device and the transmitting device and for detecting reception of the wake-up signal according to an output signal of the receiving device;
a timer device for counting a time without user service according to an output signal of the detecting device; and
a switching device for switching on or off the transmitting device, wherein the switching device switches off the transmitting device when the time without user service counted by the timer device reaches a preset time threshold, thereby making the base station operate in a sleep state, and switches on the transmitting device when the detecting device detects the wake-up signal, thereby making the base station operate in a wake-up state.

12.-18. (canceled)

19. The base station of claim 11, wherein the receiving device inputs the uplink signal of the user equipment to the detecting device after the receiving device receives and processes it, and the transmitting device generates the wake-up signal and transmits it to a neighboring base station in the sleep state when the detecting device detects that link quality of the user equipment is lower than a preset first link quality threshold.

20. The base station of claim 19 further comprising a location estimation device for estimating location information of the user equipment, wherein the transmitting device transmits the wake-up signal to only a neighboring base station in the sleep state to which the user equipment, whose link quality is lower than a preset link quality threshold, is adjacent.

21. (canceled)

22. The base station of claim 11 further comprising a resource scheduling device, wherein after the receiving device receives and processes the uplink signal of the user equipment and then inputs it to the detecting device and the detecting device detects that link quality of the user equipment is lower than a preset second link quality threshold, the resource scheduling device schedules the user equipment to transmit an uplink wake-up triggering signal and reserves resource for the user equipment to transmit the wake-up triggering signal.

23. A user equipment comprising a signal generation and transmission device for generating and transmitting an uplink wake-up triggering signal.

24. The user equipment of claim 23 further comprising a detecting device for detecting a serving base station, wherein a result of the detecting device is output to the signal generation and transmission device, and the signal generation and transmission device is switched on, generates and transmits the uplink wake-up triggering signal when the detecting device doesn't detect a serving base station whose SINR is greater than a preset threshold.

25.-27. (canceled)
